(19) United States
(12) Patent Application Publication
(10) Pub. No.: US 2025/0217580 A1
(43) Pub. Date: Jul. 3, 2025

(54) METHOD FOR EDITING ONLINE DOCUMENT, ELECTRONIC DEVICE, AND STORAGE MEDIUM

(71) Applicant: Beijing Baidu Netcom Science Technology Co., Ltd., Beijing (CN)

(72) Inventor: Hongtao ZOU, Beijing (CN)

(21) Appl. No.: 19/082,755

(22) Filed: Mar. 18, 2025

(30) Foreign Application Priority Data
Dec. 9, 2024 (CN) 202411805402.9

(51) Int. Cl. G06F 40/166

(52) U.S. Cl. CPC G06F 40/166

(57) ABSTRACT

Provided is a method for editing an online document, an electronic device, and a storage medium, relating to the fields of computer technology, document processing, document editing, and artificial intelligence. The method includes: a client sends a data acquisition request for a target file to a server in response to an open request for the target file; receives a data entity of the target file returned by the server, where the data entity comprises multiple pieces of log data; loads the data entity in a preset web view container, and displays a web view with the data entity loaded; and receives an editing instruction for the web view, displays response result data in the web view in response to the editing instruction, and sends the response result data to the server so that the server updates the data entity of the target file according to the response result data.

### CROSS-REFERENCE TO RELATED APPLICATIONS

The present application claims priority to Chinese Patent Application No. CN202411805402.9, filed with the China National Intellectual Property Administration on Dec. 9, 2024, the disclosure of which is hereby incorporated herein by reference in its entirety.

### TECHNICAL FIELD

The present disclosure relates to the field of computer technology, specifically to fields of document processing, document editing, artificial intelligence and other technologies, and particularly to a method and an apparatus for editing an online document, an electronic device, a storage medium and a product.

### BACKGROUND

With the rapid development of computer technology, online document editing comes into being, in order to facilitate document editing and sharing. Online document editing can be achieved by using the online editing function built in an application, using a third-party application, or downloading a document locally for editing, etc.

### SUMMARY

The present disclosure provides a method and an apparatus for editing an online document, an electronic device, a storage medium and a product.

According to one aspect of the present disclosure, provided is a method for editing an online document, applied to a client, including:
sending a data acquisition request for a target file to a server in response to an open request for the target file;
receiving a data entity of the target file returned by the server, where the data entity includes multiple pieces of log data;
loading the data entity in a preset web view container, and displaying a web view with the data entity loaded; and
receiving an editing instruction for the web view, displaying response result data in the web view in response to the editing instruction, and sending the response result data to the server so that the server updates the data entity of the target file according to the response result data.

According to another aspect of the present disclosure, provided is a method for editing an online document, applied to a server, including:
receiving a data acquisition request for a target file sent by a client, where the data acquisition request includes a user identifier and a file identifier of the target file;
determining a data entity corresponding to the target file based on the user identifier, the file identifier, and a correspondence among the user identifier, the file identifier and a data identifier of the data entity, where the data entity includes multiple pieces of log data;
sending the data entity to the client; and
receiving response result data sent by the client, and updating the data entity corresponding to the target file by using the response result data.

According to another aspect of the present disclosure, provided is an apparatus for editing an online document, applied to a client, including:
a first request sending module configured to send a data acquisition request for a target file to a server in response to an open request for the target file;
a data acquisition module configured to receive a data entity of the target file returned by the server, where the data entity includes multiple pieces of log data;
a data loading module configured to load the data entity in a preset web view container, and display a web view with the data entity loaded; and
an online editing module configured to receive an editing instruction for the web view, display response result data in the web view in response to the editing instruction, and send the response result data to the server so that the server updates the data entity of the target file according to the response result data.

According to another aspect of the present disclosure, provided is an apparatus for editing an online document, applied to a server, including:
a first request receiving module configured to receive a data acquisition request for a target file sent by a client, where the data acquisition request includes a user identifier and a file identifier of the target file;
a data determining module configured to determine a data entity corresponding to the target file based on the user identifier, the file identifier, and a correspondence among the user identifier, the file identifier and a data identifier of the data entity, where the data entity includes multiple pieces of log data;
a data sending module configured to send the data entity to the client; and
a data updating module configured to receive response result data sent by the client, and update the data entity corresponding to the target file by using the response result data. According to yet another aspect of the present disclosure, provided is an electronic device, including:
at least one processor; and
a memory connected in communication with the at least one processor;
where the memory stores an instruction executable by the at least one processor, and the instruction, when executed by the at least one processor, enables the at least one processor to execute the method in any one of the above-mentioned aspects.

According to another aspect of the present disclosure, provided is a non-transitory computer-readable storage medium storing a computer instruction thereon, and the computer instruction is used to cause a computer to execute the method in any one of the above-mentioned aspects.

According to another aspect of the present disclosure, provided is a computer program product including a computer program, and the computer program implements the method in any one of the above-mentioned aspects, when executed by a processor.

The embodiments of the present disclosure implement online document editing.

It should be understood that the content described in this part is not intended to identify critical or essential features of embodiments of the present disclosure, nor is it used to limit the scope of the present disclosure. Other features of the present disclosure will be easily understood through the following description.

### BRIEF DESCRIPTION OF THE DRAWINGS

The accompanying drawings are used to better understand the present solution, and do not constitute a limitation to the present disclosure.

FIG. 1 is a schematic diagram of a network disk interface according to the present disclosure;

FIG. 2 is a schematic diagram of a method for creating a file according to the present disclosure;

FIG. 3 is a schematic diagram of a method for editing an online document according to the present disclosure;

FIG. 4 is a schematic diagram of an online document editing interface according to the present disclosure;

FIG. 5 is a schematic diagram of a video playing interface according to the present disclosure;

FIG. 6a is a schematic diagram of a document editing interface according to the present disclosure;

FIG. 6b is another schematic diagram of a document editing interface according to the present disclosure;

FIG. 6c is yet another schematic diagram of a document editing interface according to the present disclosure;

FIG. 7a is a schematic diagram of an AI editing interface according to the present disclosure;

FIG. 7b is another schematic diagram of an AI editing interface according to the present disclosure;

FIG. 7c is yet another schematic diagram of an AI editing interface according to the present disclosure;

FIG. 8 is another schematic diagram of a method for editing an online document according to the present disclosure;

FIG. 9 is an interactive schematic diagram of a method for editing an online document according to the present disclosure;

FIG. 10 is a structural schematic diagram of an apparatus for editing an online document according to the present disclosure;

FIG. 11 is another structural schematic diagram of an apparatus for editing an online document according to the present disclosure; and

FIG. 12 is a block diagram of an electronic device used to implement the method for editing the online document of the embodiments of the present disclosure.

### DETAILED DESCRIPTION

Hereinafter, descriptions to exemplary embodiments of the present disclosure are made with reference to the accompanying drawings, include various details of the embodiments of the present disclosure to facilitate understanding, and should be considered as merely exemplary.

Therefore, those having ordinary skill in the art should realize, various changes and modifications may be made to the embodiments described herein, without departing from the scope and spirit of the present disclosure. Likewise, for clarity and conciseness, descriptions of well-known functions and structures are omitted in the following descriptions.

In the related technology, the document products used in online document editing such as Tencent Docs, Youdao Cloud Note and EverNote exist independently as documents, and only local resources can be used for editing during the document editing process. In actual applications, for a network disk, the user of the network disk has a large number of demands for creation or reproduction based on the data in the network disk. In order to better meet the demands of the user of the network disk for creation in the network disk, how to edit an online document in the network disk has become an urgent problem to be solved.

In order to better meet the demands of the user of the network disk for creation in the network disk and enable the user to edit an online document in the network disk, the embodiments of the present disclosure provide a method and an apparatus for editing an online document, an electronic device, a storage medium and a product.

A method for editing an online document provided by an embodiment of the present disclosure includes: a client sends a data acquisition request for a target file to a server in response to an open request for the target file; receives a data entity of the target file returned by the server, where the data entity includes multiple pieces of log data; loads the data entity in a preset web view container, and displays a web view with the data entity loaded; and receives an editing instruction for the web view, displays response result data in the web view in response to the editing instruction, and sends the response result data to the server so that the server updates the data entity of the target file according to the response result data.

In the embodiment of the present disclosure, the data entity corresponding to the target file existing in the client is stored in the server. The client pulls the corresponding data entity from the server through the open request for the target file, loads the pulled data entity in the web view container preset by the client, and displays the web view with the data entity loaded to form an online edited document. That is, the displayed web view is a document view that the user can see and edit online on the client. Further, in response to the editing instruction for the web view, the client displays the response result data in the web view, and synchronizes the data entity stored in the server by using the response result data, thereby realizing online document editing.

The method for editing the online document provided by the embodiment of the present disclosure will be described in detail below.

The method for editing the online document provided by the embodiment of the present disclosure may be applied to online document editing scenarios in a network disk. In one example, a user logs in to a personal network disk through a client, and further performs data interaction through a network connection between the client and the server, to implement online document editing. Exemplarily, the client may be a terminal device such as a laptop computer, a personal computer, etc., or may be an intelligent terminal device, etc. The server may be an online service device such as network disk cloud, network disk backend, network disk database, etc.

When the user needs to create in the network disk, for example, edit a document in the network disk, the user logs in to the personal network disk through the client. At this time, a connection is established between the client and the network disk backend, i.e., the server. The client is for example a laptop computer, a personal computer or a mobile phone, etc.

Exemplarily, as shown in FIG. 1, FIG. 1 is an example interface of the personal network disk displayed after the user logs in to the personal network disk through the client. Before the user edits an online document, the user firstly needs to create or newly create an online document. For example, the user clicks on the function control “Create online document” in FIG. 1 to newly create an online document.

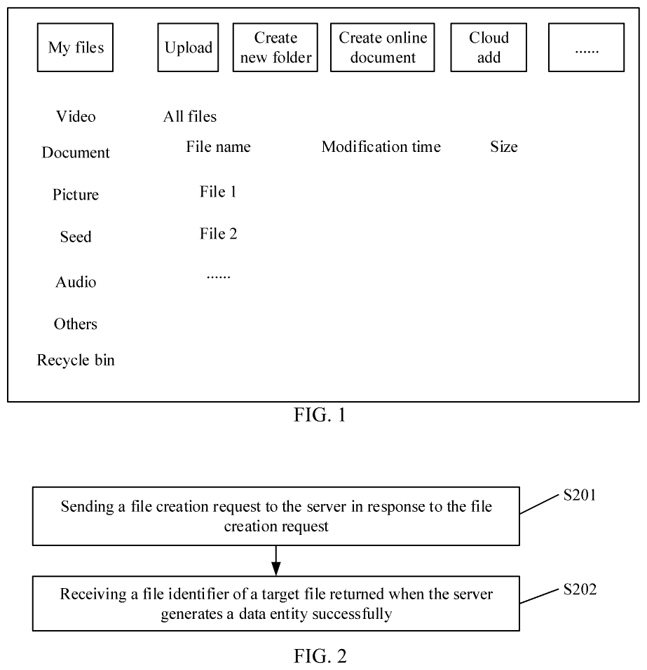

Correspondingly, referring to FIG. 2, an embodiment of the present disclosure discloses a method for creating a file, applied to the client, including:

S201: sending a file creation request to the server in response to the file creation request.

S202: receiving a file identifier of a target file returned when the server generates a data entity successfully.

Exemplarily, the user clicks on the function control “Create online document” in FIG. 1, and the client receives a file creation request from the user, where the file creation request includes a user identifier. The client sends the file creation request to the server in response to the file creation request. When receiving the file creation request sent by the client, the server generates a data entity corresponding to the file creation request and stores the data entity in a target database, which may be a network disk database. At the same time, the server generates a target file in a preset file type for the data entity, and stores the target file to a preset position, which may be storage space of a personal network disk corresponding to the user identifier. Further, the server allocates a data identifier to the data entity and a file identifier to the target file; establishes and stores a correspondence among the user identifier, the file identifier and the data identifier; and returns a message of successful creation and the file identifier of the generated target file to the client when generating the data entity and the target file successfully.

Here, the data entity may include multiple pieces of log data of the target file, such as creation time, size, content, etc. The preset file type may be, for example, file type “pnad”, represented as xxx.pand, where xxx is the file name and.pand represents the file type “pnad”. This file type may be understood as a file type similar to shortcut and application clone. In this way, when the server successfully generates the target file, the client will display the corresponding target file, and the target file will occupy the storage space of the user's personal network disk.

The target file is a file in the preset file type generated for the data entity. Accordingly, there is a mapping relationship between the generated data entity and the target file. The server also establishes and stores the correspondence among the user identifier, file identifier and data identifier, so that the client can trace the corresponding data entity on the server through the identifier of the target file.

In this way, when the client receives the file creation request, the data entity corresponding to the file creation request is generated on the server through the interaction between the client and the server, and the target file displayed on the client is generated. The target file on the client can be directly associated with the data entity on the server to facilitate subsequent implementation of online document editing.

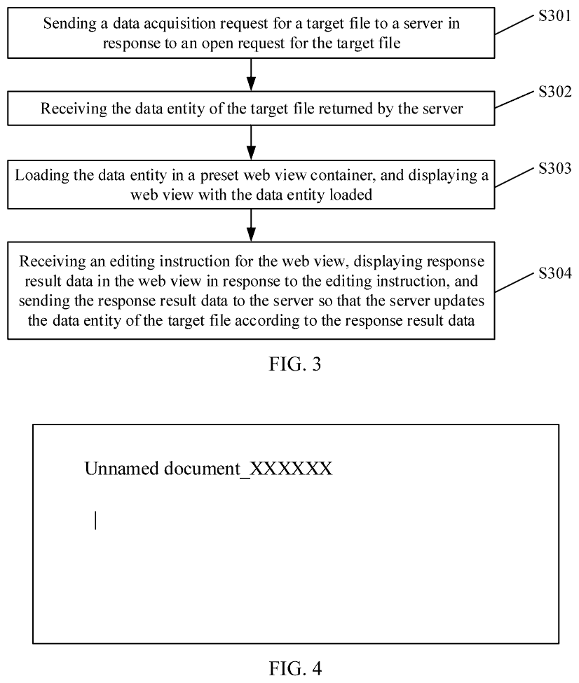

Referring to FIG. 3, FIG. 3 is a schematic flowchart of a method for editing an online document according to an embodiment of the present disclosure, applied to a client, including the following steps:

S301: sending a data acquisition request for a target file to a server in response to an open request for the target file.

In the case where the target file already exists, the data entity corresponding to the target file is stored in the server, so the operation of opening the target file requires pulling the data entity from the server for rendering.

Specifically, the user clicks on the target file to open it; and the client receives the user's open request for the target file, and sends the data acquisition request for the target file to the server in response to the open request. The data acquisition request may include a user identifier and a file identifier of the target file, to facilitate pulling the corresponding data entity from the server.

S302: receiving the data entity of the target file returned by the server.

When receiving a file creation request to generate the data entity and the target file, the server establishes and stores a correspondence between the user identifier contained in the file creation request, the file identifier of the generated target file, and the data identifier of the generated data entity. When receiving the data acquisition request from the client, the server can obtain the corresponding data entity by querying the above correspondence through the user identifier and the file identifier of the target file included in the data acquisition request, and return the data entity of the target file to the client.

The data entity contains multiple pieces of log data, each of which may represent an operation record for the target file. For example, the log data corresponding to the newly generated target file has empty file content; the log data corresponding to the target file that has been edited once contains editing content, editing time and other information; and so on.

S303: loading the data entity in a preset web view container, and displaying a web view with the data entity loaded.

After obtaining the data entity of the target file from the server, the client renders the obtained data entity in the preset web view container in the style of document. After the rendering is completed, the client displays the web view with the data entity loaded, to form an online edited document. The preset web view container may be, for example, a web view (Webview). After rendering in the style of document, the displayed web view is in the form of document. The data content contained in the web view is the data content in the data entity.

Exemplarily, as shown in FIG. 4, FIG. 4 is a web view showing the data entity being loaded, and no content has been edited in the editing interface of the web view.

S304: receiving an editing instruction for the web view, displaying response result data in the web view in response to the editing instruction, and sending the response result data to the server so that the server updates the data entity of the target file according to the response result data.

The client receives and responds to the user's editing instruction for the web view, displays the response result data in the web view, and simultaneously synchronizes the response result data to the data entity of the target file on the server.

Specifically, the response result data may be sent to the server in real time, or may be sent to the server periodically, so that the server can perform data synchronization.

In the embodiment of the present disclosure, the data entity corresponding to the target file existing in the client is stored in the server. The client pulls the corresponding data entity from the server through the open request for the target file, loads the pulled data entity in the web view container preset by the client, and displays the web view with the data entity loaded to form an online edited document. That is, the displayed web view is a document view that the user can see and edit online on the client. Further, in response to the editing instruction for the web view, the client displays the response result data in the web view, and synchronizes the data entity stored in the server by using the response result data, thereby realizing online document editing. Since the editing of the web view is performed on the client and the corresponding data entity is stored in the server, the client can pull data from the server and then can comprehensively utilize the server data and the local data in the document editing process, so as to better meet the demand of the user of the network disk for creation in the network disk, and enable the user to better utilize the data in the network disk for editing the online document.

In a possible implementation, the above-mentioned method for editing the online document may be applied to a scenario in which online notes are added or edited for a watched video. Correspondingly, the above-mentioned step of sending a file creation request to the server in response to the file creation request may include:
for a video watched by a user, receiving the user's trigger operation on a preset function in a preset function area of a video playing interface, and generating a file creation request for the watched video; and
sending the file creation request to the server in response to the file creation request, where the file creation request further includes a video identifier.

Here, the preset function area may be at a set position such as left sidebar, right sidebar, upper sidebar or lower sidebar on the video playing interface. The preset function area may also be shrunk, hidden when the user clicks on “Hide”, and displayed when the user clicks on “Display”. The preset function is, for example, note addition function, text creation function, etc.

For example, as shown in FIG. 5, the user is watching a video played in the video playing window. When the user wants to add a note to the watched video, the user clicks on the function button or control “Add note” in the right sidebar. When receiving the user's trigger operation for the function button “Add note”, the client generates a file creation request for the watched video, and sends the file creation request including a user identifier and a video identifier to the server in response to the file creation request, so that the server can generate the corresponding data entity and target file and return the file identifier of the target file. In the scenario of adding or editing online notes for the watched video, the target object is the video; and the specific generation of the data entity and target file, subsequent note editing operations and other processes are consistent with the above-mentioned process of editing the online document.

In the embodiment of the present disclosure, the function of adding video notes is implemented for the video watched by the user. When the user triggers the function button “Add note”, online notes can be added and edited during the video viewing process, which can help the user record video notes while watching the video, thus realizing the combination of the video function and document editing function.

In a possible implementation, the editing instruction includes at least one of: inserting an attachment, modifying content, or Artificial Intelligence (AI) editing.

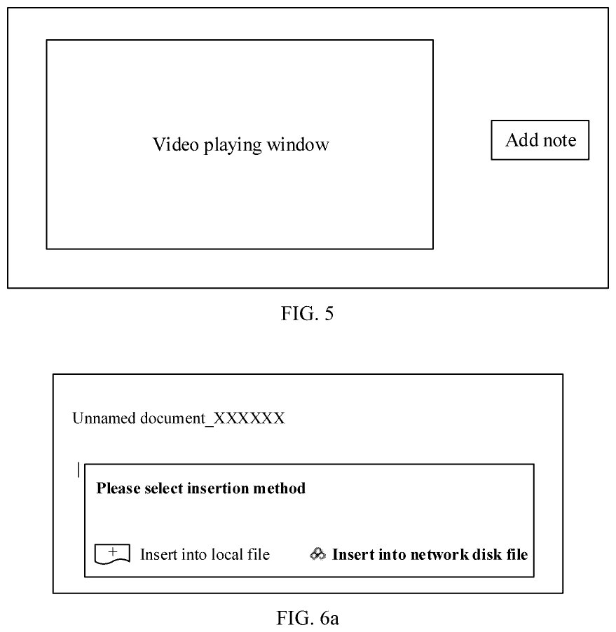

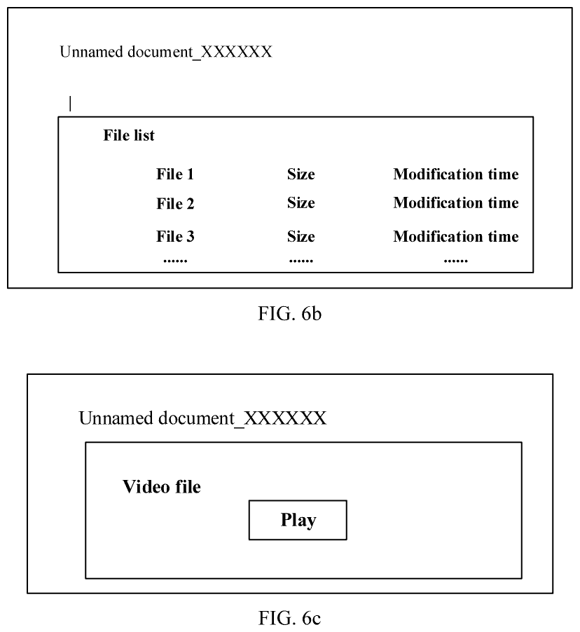

Here, inserting an attachment may be: inserting an attachment into a local file or a network disk file. For example, as shown in FIG. 6a, when the user clicks on the insertion button (not shown in FIG. 6a) on the web view in the online document editing interface (i.e., the web view), a dialog box for selecting an insertion method pops up for the user to select the insertion method. After the user selects the insertion method, a dialog box is displayed for the user to select a file to be inserted, as shown in FIG. 6b. After the user selects to insert the target file, the response result data is displayed in the web view in response to an insertion instruction. As shown in FIG. 6c, a video file is inserted, and the response result data is sent to the server, so that the server synchronously updates the data entity. After a file is inserted, the inserted file may also be browsed or previewed, for example, the play button in FIG. 6c is clicked to preview the inserted video, etc.

Modifying content may include: writing content, deleting or modifying written content, etc. AI editing means realizing the AI-assisted editing function.

In the embodiment of the present disclosure, the editing instruction includes inserting an attachment, modifying content, AI editing, etc., realizing a variety of editing methods for online documents; and the server data and the local data can be comprehensively utilized to better meet the demand of the user of the network disk for creation in the network disk, and realize writing and reading at the same time.

In a possible implementation, when the editing instruction is an AI editing instruction, the above-mentioned step S304 of receiving an editing instruction for the web view, displaying response result data in the web view in response to the editing instruction, and sending the response result data to the server, includes:
receiving the AI editing instruction for the web view, and displaying a display interface including a plurality of AI editing functions; obtaining a user's selection instruction for an AI editing function, and calling a corresponding function interface according to a selection result to obtain and display AI response data; and when receiving an instruction from the user to determine to use the AI response data, displaying the AI response data in the web view, and sending the AI response data to the server.

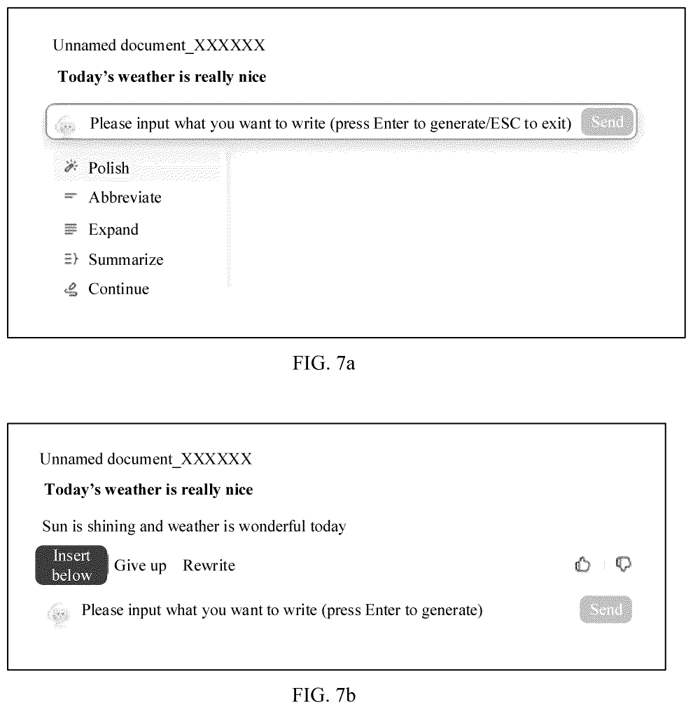

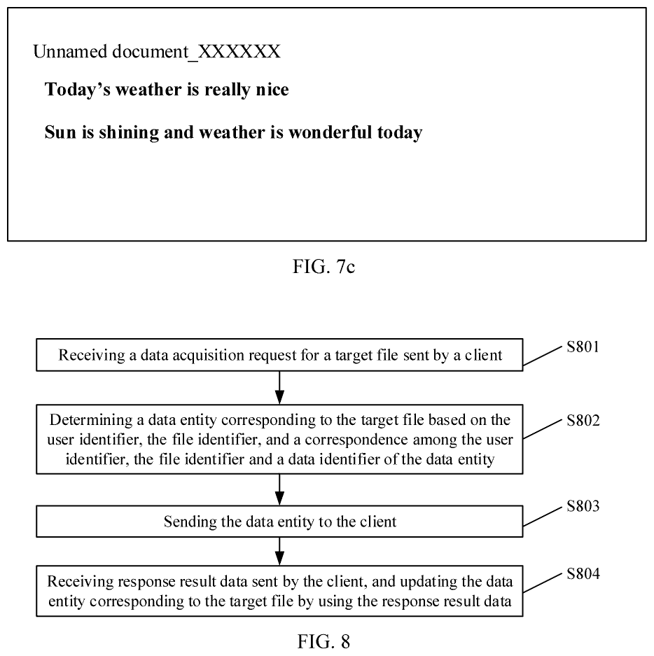

Exemplarily, as shown in FIG. 7a, after the user edits “Today's weather is really nice” in the editing interface of the web view, the user clicks the AI editing function button (not shown in FIG. 7a), and the client receives the AI editing instruction for the web view and displays a display interface containing a plurality of AI editing functions.

Here, the AI editing function includes at least one of: outline, brainstorm, polish, abbreviate, continue, expand or summarize.

In the embodiment of the present disclosure, the AI editing function can help the user to create a document from scratch, for example, help the user to outline, brainstorm, etc.; and can also help the user to polish, abbreviate, continue, expand and summarize the created content, thereby better assisting the user in creation.

When the user selects a specific AI editing function, the client obtains the user's selection instruction for the AI editing function, and calls the corresponding function interface according to the selection result to obtain and display the AI response data. Different AI editing functions correspond to different function interfaces, and the function interfaces are encapsulated with add-in functions to implement corresponding functional operations.

Exemplarily, as shown in FIG. 7b, after the user selects the polish function, the client calls the function interface corresponding to polishing to obtain the AI response data (that is, the sun is shining and the weather is wonderful today) and display the AI response data.

Afterwards, the user determines whether to use the AI response data. When receiving the user's instruction to determine to use the AI response data, the client displays the AI response data in the web view and sends the AI response data to the server.

Exemplarily, when the user chooses to use the AI response data and determines that the usage method is inserting below, the client receives the user's instruction to use the AI response data and insert it below, and displays the AI response data in the web view, as shown in FIG. 7c.

The embodiment of the present disclosure realizes the AI editing function for online document editing, can help the user to create a document from scratch, and can also help the user to polish, abbreviate, continue, expand and summarize the created content, so as to better assist the user in creation.

In one possible implementation, the AI editing instruction is a text instruction or a voice instruction; and, when the AI editing instruction is a voice instruction, the method further includes: performing intent recognition on the voice instruction, and determining an intent recognition result as the AI editing instruction.

The AI editing instruction may be an instruction manually selected or input by the user, that is, a text instruction, or may be a voice instruction. When the AI editing instruction is a voice instruction, the client may also perform intent recognition on the received voice instruction and determine the intent recognition result as the AI editing instruction.

In the embodiment of the present disclosure, the AI editing instruction may be a text instruction or a voice instruction, thereby expanding the AI editing function for online document editing; and the intent recognition can be performed on the voice instruction, thereby better assisting the user in creation.

In the embodiment of the present disclosure, the client can pull the data entity corresponding to the target file from the server by clicking the target file, render and display the web view with the data entity loaded locally on the client, and edit the online document through the web view. Regardless of whether the document is edited, the target file will be displayed locally on the client after the target file is generated. The target file local to the client has no specific data entity, and the corresponding data entity is stored in the server. Then, an embodiment of the present disclosure further provides a method for operating the target file. Specifically, on the basis of the above method, this method may further include:
in response to an operation instruction for the target file, sending the operation instruction to the server, where the operation instruction includes an operation identifier of an operation on the target file; and
receiving result information returned after the server calls a corresponding operation interface based on the operation identifier to respond to the operation instruction.

The client receives the user's operation instruction for the target file, and sends the operation instruction to the server in response to the operation instruction. The operation instruction includes the operation identifier of the operation on the target file, such as a copy identifier, a delete identifier, a move identifier, etc. Then, the server calls the corresponding operation interface based on the operation identifier to respond to the operation instruction, and returns the response result information to the client; and the client receives the result information returned by the server. The server stores operation interfaces corresponding to different operation identifiers, and the operation interfaces are encapsulated with add-on functions to implement corresponding operations. The result information returned by the server may be, for example, result information that the operation succeeds or fails, or a prompt or indication information indicating the next operation.

In the embodiment of the present disclosure, the operation on the target file of the data entity stored in the server is implemented.

Here, the operation instruction may include at least one of: download, share, transfer, export, print, move, copy, favorite or delete.

In the embodiment of the present disclosure, diversified operations on the target file of the data entity stored in the server are implemented.

Referring to FIG. 8, FIG. 8 is a schematic flowchart of another method for editing an online document according to an embodiment of the present disclosure, applied to a server, including the following steps:

S801: receiving a data acquisition request for a target file sent by a client.

The data acquisition request includes a user identifier and a file identifier of the target file.

S802: determining a data entity corresponding to the target file based on the user identifier, the file identifier, and a correspondence among the user identifier, the file identifier and a data identifier of the data entity.

The data entity includes multiple pieces of log data.

S803: sending the data entity to the client.

S804: receiving response result data sent by the client, and updating the data entity corresponding to the target file by using the response result data.

In the embodiment of the present disclosure, the data entity corresponding to the target file existing in the client is stored in the server. The client pulls the corresponding data entity from the server through the open request for the target file, loads the pulled data entity in the web view container preset by the client, and displays the web view with the data entity loaded to form an online edited document. Further, the client sends the response result data corresponding to the editing instruction for the web view to the server, and then the server can synchronously update the stored data entity by using the response result data, thereby realizing online document editing. Moreover, since the editing of the web view is performed on the client and the corresponding data entity is stored in the server, the client pulls data from the server and then can comprehensively utilize the server data and the local data in the document editing process, so as to better meet the demand of the user of the network disk for creation in the network disk, and enable the user to better utilize the data in the network disk for editing the online document.

In a possible implementation, the method further includes:
receiving a file creation request sent by the client, where the file creation request includes a user identifier;
generating a data entity corresponding to the file creation request, and storing the data entity in a target database;
generating a target file in a preset file type for the data entity, and storing the target file to a preset position;
allocating a data identifier to the data entity and a file identifier to the target file, and establishing and storing a correspondence among the user identifier, the file identifier and the data identifier; and
returning the file identifier of the target file to the client when generating the data entity and the target file successfully.

Also, when the network connection between the client and the server is disconnected or the capacity of the cloud disk corresponding to the server is insufficient, the server fails to generate the data entity and the target file, and the server returns a creation failure message to the client.

In the embodiment of the present disclosure, the data entity corresponding to the file creation request is generated on the server through the interaction between the client and the server, and the target file displayed on the client is generated. The target file on the client can be directly associated with the data entity on the server to facilitate subsequent implementation of online document editing.

In a possible implementation, the step of receiving a file creation request sent by the client includes: receiving a file creation request for a watched video sent by the client, where the file creation request further includes a video identifier.

Correspondingly, the step of establishing and storing a correspondence among the user identifier, the file identifier and the data identifier includes: establishing and storing a correspondence among the user identifier, the video identifier, the file identifier and the data identifier.

The step of storing the target file to a preset position includes: storing the target file to a storage directory of the watched video.

In the embodiment of the present disclosure, the function of adding video notes is implemented for the video watched by the user. When the user triggers the function button “Add note”, online notes can be added and edited during the video viewing process, which can help the user record video notes while watching the video, thus realizing the combination of the video function and document editing function. The target file is stored to the storage directory of the watched video, to facilitate the better management of videos and video notes.

In a possible implementation, the method further includes:
receiving an operation instruction for the target file sent by the client, where the operation instruction includes an operation identifier of an operation on the target file; and
calling a corresponding operation interface based on the operation identifier to respond to the operation instruction, and returning response result information to the client.

In the embodiment of the present disclosure, the operation on the target file of the data entity stored in the server is implemented.

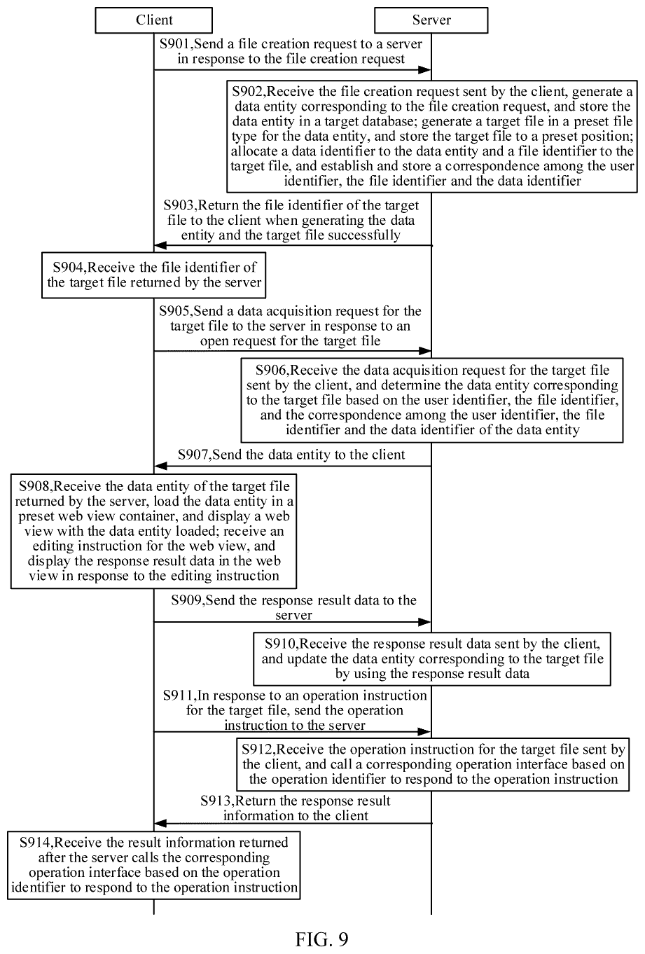

Exemplarily, as shown in FIG. 9, an embodiment of the present disclosure provides a method for editing an online document, including:

S901: a client sends a file creation request to a server in response to the file creation request.

The file creation request includes a user identifier.

In a scenario where a user watches a video, for the video watched by the user, the client may also receive the user's trigger operation on a preset function in a preset function area of a video playing interface, and generate a file creation request for the watched video; and then, the file creation request sent by the client to the server further includes a video identifier.

S902: the server receives the file creation request sent by the client, generates a data entity corresponding to the file creation request, and stores the data entity in a target database; generates a target file in a preset file type for the data entity, and stores the target file to a preset position; allocates a data identifier to the data entity and a file identifier to the target file, and establishes and stores a correspondence among the user identifier, the file identifier and the data identifier.

S903: the server returns the file identifier of the target file to the client when generating the data entity and the target file successfully.

Corresponding to the above-mentioned scenario where the user watches the video, the file creation request received by the server further includes the video identifier. After the data identifier is allocated to the data entity and the file identifier is allocated to the target file, a correspondence among the user identifier, video identifier, file identifier and data identifier is established and stored. The step of storing the target file to a preset position is storing the target file to a storage directory of the watched video.

S904: the client receives the file identifier of the target file returned by the server.

S905: the client sends a data acquisition request for the target file to the server in response to an open request for the target file.

The data acquisition request includes a user identifier and a file identifier of the target file.

S906: the server receives the data acquisition request for the target file sent by the client, and determines the data entity corresponding to the target file based on the user identifier, the file identifier, and the correspondence among the user identifier, the file identifier and the data identifier of the data entity.

The data entity includes multiple pieces of log data.

S907: the server sends the data entity to the client.

S908: the client receives the data entity of the target file returned by the server, loads the data entity in a preset web view container, and displays a web view with the data entity loaded; receives an editing instruction for the web view, and displays the response result data in the web view in response to the editing instruction.

The editing instruction includes at least one of: inserting an attachment, modifying content, or AI editing.

When the editing instruction is an AI editing instruction, the client receives the AI editing instruction for the web view, and displays a display interface including a plurality of AI editing functions; obtains the user's selection instruction for an AI editing function, and calls a corresponding function interface according to a selection result to obtain and display the AI response data; and when receiving an instruction from the user to determine to use the AI response data, displays the AI response data in the web view, and sends the AI response data to the server.

The AI editing instruction is a text instruction or a voice instruction. When the AI editing instruction is a voice instruction, the client performs intent recognition on the voice instruction and determines an intent recognition result as the AI editing instruction.

The AI editing function includes at least one of: outline, brainstorm, polish, abbreviate, continue, expand or summarize.

S909: the client sends the response result data to the server.

S910: the server receives the response result data sent by the client, and updates the data entity corresponding to the target file by using the response result data.

S911: the client, in response to an operation instruction for the target file, sends the operation instruction to the server.

The operation instruction includes an operation identifier of an operation on the target file. The operation instruction includes at least one of: download, share, transfer, export, print, move, copy, favorite or delete.

S912: the server receives the operation instruction for the target file sent by the client, and calls a corresponding operation interface based on the operation identifier to respond to the operation instruction.

S913: the server returns the response result information to the client.

S914: the client receives the result information returned after the server calls the corresponding operation interface based on the operation identifier to respond to the operation instruction.

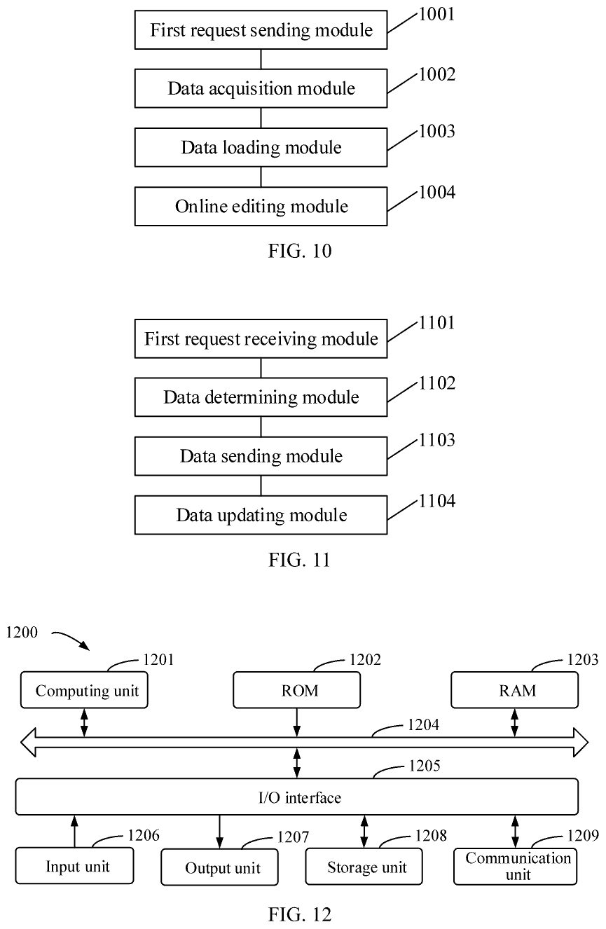

An embodiment of the present disclosure further provides an apparatus for editing an online document, applied to a client, as shown in FIG. 10, including:
a first request sending module 1001 configured to send a data acquisition request for a target file to a server in response to an open request for the target file;
a data acquisition module 1002 configured to receive a data entity of the target file returned by the server, where the data entity includes multiple pieces of log data;
a data loading module 1003 configured to load the data entity in a preset web view container, and display a web view with the data entity loaded; and
an online editing module 1004 configured to receive an editing instruction for the web view, display response result data in the web view in response to the editing instruction, and send the response result data to the server so that the server updates the data entity of the target file according to the response result data.

In a possible implementation, the apparatus further includes:
a second request sending module configured to send a file creation request to the server in response to the file creation request, where the file creation request includes a user identifier; and
an identifier receiving module configured to receive a file identifier of the target file returned when the server generates the data entity successfully.

In a possible implementation, the second request sending module is specifically configured to:
for a video watched by a user, receive the user's trigger operation on a preset function in a preset function area of a video playing interface, and generate a file creation request for the watched video; and
send the file creation request to the server in response to the file creation request, where the file creation request further includes a video identifier.

In a possible implementation, the editing instruction includes at least one of: inserting an attachment, modifying content, or AI editing.

In a possible implementation, when the editing instruction is an AI editing instruction, the online editing module 1004 is specifically configured to:
receive the AI editing instruction for the web view, and display a display interface including a plurality of AI editing functions;
obtain a user's selection instruction for an AI editing function, and call a corresponding function interface according to a selection result to obtain and display AI response data; and
when receiving an instruction from the user to determine to use the AI response data, display the AI response data in the web view, and send the AI response data to the server.

In one possible implementation, the AI editing instruction is a text instruction or a voice instruction; and
when the AI editing instruction is a voice instruction, the apparatus further includes:
an intent recognition module configured to perform intent recognition on the voice instruction, and determine an intent recognition result as the AI editing instruction.

In a possible implementation, the AI editing function includes at least one of: outline, brainstorm, polish, abbreviate, continue, expand or summarize.

In a possible implementation, the apparatus further includes:
an instruction sending module configured to, in response to an operation instruction for the target file, send the operation instruction to the server, where the operation instruction includes an operation identifier of an operation on the target file; and
a result acquisition module configured to receive result information returned after the server calls a corresponding operation interface based on the operation identifier to respond to the operation instruction.

In a possible implementation, the operation instruction includes at least one of: download, share, transfer, export, print, move, copy, favorite or delete.

An embodiment of the present disclosure further provides an apparatus for editing an online document, applied to a server, as shown in FIG. 11, including:
a first request receiving module 1101 configured to receive a data acquisition request for a target file sent by a client, where the data acquisition request includes a user identifier and a file identifier of the target file;
a data determining module 1102 configured to determine a data entity corresponding to the target file based on the user identifier, the file identifier, and a correspondence among the user identifier, the file identifier and a data identifier of the data entity, where the data entity includes multiple pieces of log data;
a data sending module 1103 configured to send the data entity to the client; and
a data updating module 1104 configured to receive response result data sent by the client, and update the data entity corresponding to the target file by using the response result data.

In a possible implementation, the apparatus further includes:
a second request receiving module configured to receive a file creation request sent by the client, where the file creation request includes a user identifier;
a first generating module configured to generate a data entity corresponding to the file creation request, and store the data entity in a target database;
a second generating module configured to generate a target file in a preset file type for the data entity, and store the target file to a preset position;
a relationship establishment module configured to allocate a data identifier to the data entity and a file identifier to the target file, and establish and store a correspondence among the user identifier, the file identifier and the data identifier; and
an identifier returning module configured to return the file identifier of the target file to the client when generating the data entity and the target file successfully.

In a possible implementation, the second request receiving module is specifically configured to receive a file creation request for a watched video sent by the client, where the file creation request further includes a video identifier;
the relationship establishment module is specifically configured to establish and store a correspondence among the user identifier, the video identifier, the file identifier and the data identifier; and
the second generating module is specifically configured to generate the target file in the preset file type for the data entity, and store the target file to a storage directory of the watched video.

In a possible implementation, the apparatus further includes:
an instruction receiving module configured to receive an operation instruction for the target file sent by the client, where the operation instruction includes an operation identifier of an operation on the target file; and
an instruction execution module configured to call a corresponding operation interface based on the operation identifier to respond to the operation instruction, and return response result information to the client.

According to the embodiments of the present disclosure, the present disclosure also provides an electronic device, a readable storage medium and a computer program product.

The present disclosure provides an electronic device, including:
at least one processor; and
a memory connected in communication with the at least one processor;
where the memory stores an instruction executable by the at least one processor, and the instruction, when executed by the at least one processor, enables the at least one processor to execute the method of any embodiment of the present disclosure.

The present disclosure provides a non-transitory computer-readable storage medium storing a computer instruction thereon, and the computer instruction is used to cause a computer to execute the method of any embodiment of the present disclosure.

The present disclosure provides a computer program product including a computer program, and the computer program implements the method of any embodiment of the present disclosure, when executed by a processor.

In the technical solution of the present disclosure, the collection, storage, use, processing, transmission, provision and disclosure of the user's personal information involved are in compliance with relevant laws and regulations, and do not violate public order and good customs.

FIG. 12 shows a schematic block diagram of an exemplary electronic device 1200 that may be used to implement the embodiments of the present disclosure. The electronic device is intended to represent various forms of digital computers, such as a laptop, a desktop, a workstation, a personal digital assistant, a server, a blade server, a mainframe computer, and other suitable computers. The electronic device may also represent various forms of mobile devices, such as a personal digital processing, a cellular phone, a smart phone, a wearable device and other similar computing devices. The components shown herein, their connections and relationships, and their functions are merely examples, and are not intended to limit the implementation of the present disclosure described and/or required herein.

As shown in FIG. 12, the device 1200 includes a computing unit 1201 that may perform various appropriate actions and processes according to a computer program stored in a Read-Only Memory (ROM) 1202 or a computer program loaded from a storage unit 1208 into a Random Access Memory (RAM) 1203. Various programs and data required for an operation of device 1200 may also be stored in the RAM 1203. The computing unit 1201, the ROM 1202 and the RAM 1203 are connected to each other through a bus 1204. The input/output (I/O) interface 1205 is also connected to the bus 1204.

A plurality of components in the device 1200 are connected to the I/O interface 1205, and include an input unit 1206 such as a keyboard, a mouse, or the like; an output unit 1207 such as various types of displays, speakers, or the like; the storage unit 1208 such as a magnetic disk, an optical disk, or the like; and a communication unit 1209 such as a network card, a modem, a wireless communication transceiver, or the like. The communication unit 1209 allows the device 1200 to exchange information/data with other devices through a computer network such as the Internet and/or various telecommunication networks.

The computing unit 1201 may be various general-purpose and/or special-purpose processing components with processing and computing capabilities. Some examples of the computing unit 1201 include, but are not limited to, a Central Processing Unit (CPU), a Graphics Processing Unit (GPU), various dedicated Artificial Intelligence (AI) computing chips, various computing units that run machine learning model algorithms, a Digital Signal Processor (DSP), and any appropriate processors, controllers, microcontrollers, or the like. The computing unit 1201 performs various methods and processing described above, such as the method for editing the online document. For example, in some implementations, the method for editing the online document may be implemented as a computer software program tangibly contained in a computer-readable medium, such as the storage unit 1208. In some implementations, a part or all of the computer program may be loaded and/or installed on the device 1200 via the ROM 1202 and/or the communication unit 1209. When the computer program is loaded into the RAM 1203 and executed by the computing unit 1201, one or more steps of the method for editing the online document described above may be performed. Alternatively, in other implementations, the computing unit 1201 may be configured to perform the method for editing the online document by any other suitable means (e.g., by means of firmware).

Various implementations of the system and technologies described above herein may be implemented in a digital electronic circuit system, an integrated circuit system, a Field Programmable Gate Array (FPGA), an Application Specific Integrated Circuit (ASIC), an Application Specific Standard Product (ASSP), a System on Chip (SOC), a Complex Programmable Logic Device (CPLD), a computer hardware, firmware, software, and/or a combination thereof. These various implementations may be implemented in one or more computer programs, and the one or more computer programs may be executed and/or interpreted on a programmable system including at least one programmable processor. The programmable processor may be a special-purpose or general-purpose programmable processor, may receive data and instructions from a storage system, at least one input device, and at least one output device, and transmit the data and the instructions to the storage system, the at least one input device, and the at least one output device.

The program code for implementing the method of the present disclosure may be written in any combination of one or more programming languages. The program code may be provided to a processor or controller of a general-purpose computer, a special-purpose computer or other programmable data processing devices, which enables the program code, when executed by the processor or controller, to cause the function/operation specified in the flowchart and/or block diagram to be implemented. The program code may be completely executed on a machine, partially executed on the machine, partially executed on the machine as a separate software package and partially executed on a remote machine, or completely executed on the remote machine or a server.

In the context of the present disclosure, a machine-readable medium may be a tangible medium, which may contain or store a procedure for use by or in connection with an instruction execution system, device or apparatus. The machine-readable medium may be a machine-readable signal medium or a machine-readable storage medium. The machine-readable medium may include, but is not limited to, an electronic, magnetic, optical, electromagnetic, infrared or semiconductor system, device or apparatus, or any suitable combination thereof. More specific examples of the machine-readable storage medium may include electrical connections based on one or more lines, a portable computer disk, a hard disk, a Random Access Memory (RAM), a Read-Only Memory (ROM), an Erasable Programmable Read-Only Memory (EPROM or a flash memory), an optical fiber, a portable Compact Disc Read-Only Memory (CD-ROM), an optical storage device, a magnetic storage device, or any suitable combination thereof.

In order to provide interaction with a user, the system and technologies described herein may be implemented on a computer that has: a display apparatus (e.g., a cathode ray tube (CRT) or a Liquid Crystal Display (LCD) monitor) for displaying information to the user; and a keyboard and a pointing device (e.g., a mouse or a trackball) through which the user may provide input to the computer. Other types of devices may also be used to provide interaction with the user. For example, feedback provided to the user may be any form of sensory feedback (e.g., visual feedback, auditory feedback, or tactile feedback), and the input from the user may be received in any form (including an acoustic input, a voice input, or a tactile input).

The system and technologies described herein may be implemented in a computing system (which serves as, for example, a data server) including a back-end component, or in a computing system (which serves as, for example, an application server) including a middleware, or in a computing system including a front-end component (e.g., a user computer with a graphical user interface or web browser through which the user may interact with the implementation of the system and technologies described herein), or in a computing system including any combination of the back-end component, the middleware component, or the front-end component. The components of the system may be connected to each other through any form or kind of digital data communication (e.g., a communication network). Examples of the communication network include a Local Area Network (LAN), a Wide Area Network (WAN), and the Internet.

A computer system may include a client and a server. The client and server are generally far away from each other and usually interact with each other through a communication network. A relationship between the client and the server is generated by computer programs running on corresponding computers and having a client-server relationship with each other. The server may be a cloud server, a distributed system server, or a blockchain server.

It should be understood that, the steps may be reordered, added or removed by using the various forms of the flows described above. For example, the steps recorded in the present disclosure can be performed in parallel, in sequence, or in different orders, as long as a desired result of the technical scheme disclosed in the present disclosure can be realized, which is not limited herein.

The foregoing specific implementations do not constitute a limitation on the protection scope of the present disclosure. Those having ordinary skill in the art should understand that, various modifications, combinations, sub-combinations and substitutions may be made according to a design requirement and other factors. Any modification, equivalent replacement, improvement or the like made within the spirit and principle of the present disclosure shall be included in the protection scope of the present disclosure.

What is claimed is:

1. A method for editing an online document, applied to a client, comprising:
sending a data acquisition request for a target file to a server in response to an open request for the target file;
receiving a data entity of the target file returned by the server, wherein the data entity comprises multiple pieces of log data;
loading the data entity in a preset web view container, and displaying a web view with the data entity loaded; and
receiving an editing instruction for the web view, displaying response result data in the web view in response to the editing instruction, and sending the response result data to the server so that the server updates the data entity of the target file according to the response result data.

2. The method of claim 1, further comprising:
sending a file creation request to the server in response to the file creation request, wherein the file creation request comprises a user identifier; and
receiving a file identifier of the target file returned in a case of the server generates the data entity successfully.

3. The method of claim 2, wherein the sending a file creation request to the server in response to the file creation request, comprises:
for a video watched by a user, receiving the user's trigger operation on a preset function in a preset function area of a video playing interface, and generating a file creation request for the watched video; and
sending the file creation request to the server in response to the file creation request, wherein the file creation request further comprises a video identifier.

4. The method of claim 1, wherein the editing instruction comprises Artificial Intelligence (AI) editing.

5. The method of claim 4, wherein the receiving an editing instruction for the web view, displaying response result data in the web view in response to the editing instruction, and sending the response result data to the server, comprises:
receiving the AI editing instruction for the web view, and displaying a display interface comprising a plurality of AI editing functions;
obtaining a user's selection instruction for an AI editing function, and calling a corresponding function interface according to a selection result to obtain and display AI response data; and
in a case of an instruction is received from the user to determine to use the AI response data, displaying the AI response data in the web view, and sending the AI response data to the server.

6. The method of claim 5, wherein the AI editing instruction is a text instruction or a voice instruction; and
in a case of the AI editing instruction is a voice instruction, the method further comprises:
performing intent recognition on the voice instruction, and determining an intent recognition result as the AI editing instruction.

7. The method of claim 5, wherein the AI editing function comprises at least one of: outline, brainstorm, polish, abbreviate, continue, expand or summarize.

8. The method of claim 1, wherein the editing instruction comprises at least one of: inserting an attachment, modifying content, or Artificial Intelligence (AI) editing.

9. The method of claim 1, further comprising:
in response to an operation instruction for the target file, sending the operation instruction to the server, wherein the operation instruction comprises an operation identifier of an operation on the target file; and
receiving result information returned after the server calls a corresponding operation interface based on the operation identifier to respond to the operation instruction.

10. The method of claim 9, wherein the operation instruction comprises at least one of:
download, share, transfer, export, print, move, copy, favorite or delete.

11. A method for editing an online document, applied to a server, comprising:
receiving a data acquisition request for a target file sent by a client, wherein the data acquisition request comprises a user identifier and a file identifier of the target file;
determining a data entity corresponding to the target file based on the user identifier, the file identifier, and a correspondence among the user identifier, the file identifier and a data identifier of the data entity, wherein the data entity comprises multiple pieces of log data;
sending the data entity to the client; and
receiving response result data sent by the client, and updating the data entity corresponding to the target file by using the response result data.

12. The method of claim 11, further comprising:
receiving a file creation request sent by the client, wherein the file creation request comprises a user identifier;
generating a data entity corresponding to the file creation request, and storing the data entity in a target database;
generating a target file in a preset file type for the data entity, and storing the target file to a preset position;
allocating a data identifier to the data entity and a file identifier to the target file, and establishing and storing a correspondence among the user identifier, the file identifier and the data identifier; and
returning the file identifier of the target file to the client in a case of the data entity and the target file are generated successfully.

13. The method of claim 12, wherein the receiving a file creation request sent by the client, comprises: receiving a file creation request for a watched video sent by the client, wherein the file creation request further comprises a video identifier;
wherein the establishing and storing a correspondence among the user identifier, the file identifier and the data identifier, comprises: establishing and storing a correspondence among the user identifier, the video identifier, the file identifier and the data identifier; and
wherein the storing the target file to a preset position, comprises: storing the target file to a storage directory of the watched video.

14. The method of claim 11, further comprising:
receiving an operation instruction for the target file sent by the client, wherein the operation instruction comprises an operation identifier of an operation on the target file; and
calling a corresponding operation interface based on the operation identifier to respond to the operation instruction, and returning response result information to the client.

15. The method of claim 12, further comprising:
receiving an operation instruction for the target file sent by the client, wherein the operation instruction comprises an operation identifier of an operation on the target file; and
calling a corresponding operation interface based on the operation identifier to respond to the operation instruction, and returning response result information to the client.

16. The method of claim 13, further comprising:
receiving an operation instruction for the target file sent by the client, wherein the operation instruction comprises an operation identifier of an operation on the target file; and
calling a corresponding operation interface based on the operation identifier to respond to the operation instruction, and returning response result information to the client.

17. An electronic device, comprising:
at least one processor; and
a memory connected in communication with the at least one processor;
wherein the memory stores an instruction executable by the at least one processor, and the instruction, when executed by the at least one processor, enables the at least one processor to execute the method of claim 1.

18. An electronic device, comprising:
at least one processor; and
a memory connected in communication with the at least one processor;
wherein the memory stores an instruction executable by the at least one processor, and the instruction, when executed by the at least one processor, enables the at least one processor to execute the method of claim 11.

19. A non-transitory computer-readable storage medium storing a computer instruction thereon, wherein the computer instruction is used to cause a computer to execute the method of claim 1.

20. A non-transitory computer-readable storage medium storing a computer instruction thereon, wherein the computer instruction is used to cause a computer to execute the method of claim 11.
